(19) United States
(12) Patent Application Publication
(10) Pub. No.: US 2006/0241001 A1
(43) Pub. Date: Oct. 26, 2006

(54) Composition for treating contact lenses

(75) Inventors: Zhenze Hu, Pittsford, NY (US); Andrea Lever, Pittsford, NY (US); Lisa C. Simpson, Rochester, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/472,233

(22) Filed: Jun. 21, 2006

Related U.S. Application Data
(62) Division of application No. 10/314,753, filed on Dec. 9, 2002.
(60) Provisional application No. 60/342,869, filed on Dec. 20, 2001.

(51) Int. Cl. C11D 3/00

(52) U.S. Cl. 510/112

(57) ABSTRACT

The present invention includes an ophthalmically acceptable composition comprising surfactants including poloxomine 1107 and poloxomer 407; and a biguanide antimicrobial agent in amount effective to disinfect a contact lens. The present invention also comprises a method of cleaning and disinfecting contact lenses using the ophthalmically acceptable composition set forth above.

### CROSS REFERENCE TO RELATED APPLICATIONS

This application is a divisional of co-pending U.S. patent application Ser. No. 10/314,753 filed Dec. 9, 2002, which claims the benefit of U.S. Provisional Application No. 60/342,869 filed Dec. 20, 2001, herein incorporated by reference.

### FIELD OF THE INVENTION

This invention relates to compositions and methods for cleaning, and preferably disinfecting contact lenses.

### BACKGROUND OF THE INVENTION

In the normal course of wearing contact lenses, tear film and debris composed of proteinaceous, oily, sebaceous, and related organic matter have a tendency to deposit and build up on lens surfaces. As part of the routine care regimen, contact lenses must be cleaned to remove these tear film deposits and debris. If these deposits are not properly removed, both the wettability and optical clarity of the lenses are substantially reduced causing discomfort for the wearer.

Conventionally, the cleaning of contact lenses is accomplished with one or both of two general classes of cleaners. Surfactant cleaners, generally known as “daily cleaners” because of their recommended daily use, are effective for the removal of most carbohydrate and lipid derived matter. For this daily cleaning regimen, the contact lens is removed from the eye and treated with the surfactant cleaner. However, these cleaners are not as effective for the removal of proteinaceous matter such as lysozyme. Typically, proteolytic enzymes derived from plant, animal, and microbial sources are used to remove the proteinaceous deposits. These enzymatic cleaners are typically recommended for weekly use and are conventionally employed by dissolving enzyme tablets or liquid enzyme formulations in suitable aqueous solutions, where the contact lens is soaked in the solution.

Proteinaceous matter deposited on a contact lens surface mainly includes proteins native to the eye, such as lysozyme, albumin and mucin. One of the reasons proteinaceous matter deposited on a contact lens is more difficult to remove is that the proteins typically denature once they accumulate on the contact lens surface; the denaturation allows a greater hydrophobic interaction with the hydrophilic contact lens surface. In other words, denatured proteins are more difficult to remove from a contact lens surface than native proteins. Additionally, whereas proteins native to the eye typically do not irritate the eye, denatured proteins on a contact lens surface tend to reduce comfort.

The present invention recognizes that it would be advantageous to reduce the amount of denatured protein on a contact lens, thus rendering the protein easier to remove and the contact lenses easier to clean.

U.S. Pat. No. 6,096,138 (Heiler et al.) discloses compositions including a moderately charged polyquaternium polymer that may be used as either an in-the-eye or an out-of-eye inhibitor of proteinaceous deposits on hydrophilic contact lenses, where the polyquaternium polymer inhibits the deposition of protein on contact lenses.

U.S. Pat. No. 5,422,073 (Mowrey-McKee et al.) discloses compositions for disinfecting contact lens containing tromethamine in an amount of 0.6 to 2 weight percent, where tromethamine has a synergistic microbicidal effect when employed with other antimicrobial agents such as polyhexamethylene biguanide (PHMB). This patent does not suggest that the tromethamine has any effect in stabilizing proteins against denaturation.

### SUMMARY OF THE INVENTION

According to one embodiment of the present invention, there is a ophthalmically acceptable composition comprising an aqueous solution of a surfactant comprising poloxymene 1107 and poloxymer 407. The composition also includes a biguanide anti-microbial agent in an amount effective to disinfect a contact lens. In another embodiment, the composition further comprises a total amount of surfactant that ranges from about 0.01 to about 15 wt. %.

In another embodiment, the composition further comprises a cationic polysaccharide. Preferably, the composition further comprises the polyquaternium-10 cationic polysaccharide.

In one embodiment, the amount of cationic polysaccharide or particularly polyquaternium-10 ranges from about 0.01 to about 5 wt. %. In another embodiment, the composition further comprises hydroxyalkyl phosphonate.

In still another embodiment, the composition further comprises a buffer selected from the group consisting of borate buffers, phosphate buffers, citrate buffers, bicarbonate buffers and combinations thereof.

In another embodiment, there is a method of cleaning and disinfecting contact lenses comprising soaking the contact lens in an ophthalmically acceptable composition and rinsing the contact lens.

In another embodiment, the present invention comprises a contact lens cleaning and disinfecting solution comprising an ophthalmically acceptable aqueous solution containing a surfactant comprising poloxamine 1107 and poloxomer 407. The composition further comprising a biguanide antimicrobial agent in an amount effect to disinfect a contact lens. The composition further comprises a cationic polysaccharide, according to another aspect of the invention.

### DETAILED DESCRIPTION OF THE INVENTION

The present invention may be used with all contact lenses such as conventional hard, soft, rigid and soft gas permeable, and silicone (including both hydrogel and non-hydrogel) lenses, but is preferably employed with soft hydrogel lenses. Such lenses are commonly prepared from hydrophilic monomers such as 2-hydroxyethyl(meth)acrylate, N-vinylpyrrolidone, glycerol(meth)acrylate, and (meth)acrylic acid. In the case of silicone hydrogel lenses, a silicone-containing monomer is copolymerized with at least one hydrophilic monomer. Such lenses absorb significant amounts of water, typically from 10 to 80 percent and more typically 20 to 70 percent by weight water.

The compositions employed in this invention are aqueous solutions. The compositions include, as an essential component, 2-amino-2-hydroxymethyl-1,3-propanediol, also known by the names tris(hydroxymethyl)aminomethane, tromethamine and TRIS. This compound is known as a buffer for contact lens solutions and is commercially available. In the present solutions, tromethamine is employed in amount effective to prevent or reduce denaturation of proteins, preferably at least 0.05 weight percent, more preferably 0.05 to 1%, and most preferably 0.1 to 0.5%. Tromethamine is commercially available, for example, under the trademark Tris Amino® (Angus Chemical Company, Northbrook, Ill.).

According to various preferred embodiments, the compositions are suitable for disinfecting a contact lens soaked therein. Accordingly, in addition to water and tromethamine, it is preferred that the compositions include at least one antimicrobial agent, especially a non-oxidative antimicrobial agent which derives its antimicrobial activity through a chemical or physicochemical interaction with organisms. So that the contact lenses treated with the composition may be instilled directly in the eye, i.e., without rinsing the contact lens with a separate composition, the antimicrobial agent needs to be an ophthalmically acceptable antimicrobial agent.

Suitable antimicrobial agents include quaternary ammonium salts, which do not include significant hydrophobic portions, e.g. alkyl chains comprising more than six carbon atoms. Examples of suitable quaternary ammonium salts for use in the present invention include poly[(dimethyliminio)-2-butene-1,4-diyl chloride] and [4-tris(2-hydroxyethyl)ammonio]-2-butenyl-w-[tris(2-hydroxyethyl)ammonio]dichloride (chemical registry no. 75345-27-6) generally available as Polyquaternium™ 1 (ONYX Scientific Limited, Sunderland, United Kingdom), biguanides and their salts such as alexidine and polyhexamethylene biguanides such as PHMB available under the tradename Cosmocil™ CQ (ICI Americas, Inc., Wilmington Del.), benzalkonium chloride (BAK), and sorbic acid.

The antimicrobial agent is present in an amount effective for disinfecting a contact lens, as in conventional lens soaking and disinfecting solutions. Preferably, a disinfecting amount is an amount which will reduce the microbial burden by a certain number of log orders within a certain period of time, depending on the particular microorganism involved. Most preferably, a disinfecting amount is an amount which will eliminate the microbial burden on a contact lens when used in regimen for the recommended soaking time (FDA Chemical Disinfection Efficacy Test—July, 1985 Contact Lens Solution Draft Guidelines). It is noted that, unlike the aforementioned U.S. Pat. No. 5,422,073, tromethamine does not necessarily need to be employed at higher concentrations such that tromethamine contributes to the disinfection efficacy of the composition. In other words, although relatively high amounts of tromethamine may be employed in the present compositions, it has been found in the present invention that lower amounts of tromethamine may be employed to achieve the desired protein stabilization than the amounts required in U.S. Pat. No. 5,422,073 for disinfection efficacy. Accordingly, for various preferred embodiments, the antimicrobial agent is present in an amount effective to disinfect the contact lens, where this amount is effective even in a comparable composition lacking any tromethamine.

The subject compositions may contain various other components including, but not limited to chelating and/or sequestering agents, osmolality adjusting agents, surfactants and/or wetting agents.

Chelating agents, also referred to as sequestering agents, are frequently employed in conjunction with antimicrobial agents. These agents bind heavy metal ions, which might otherwise react with the lens and/or protein deposits and collect on the lens. Chelating agents are well known in the art, and examples of preferred chelating agents include ethylenediaminetetraacetic acid (EDTA) and its salts, especially disodium EDTA. Such agents are normally employed in amounts from about 0.01 to about 2.0 weight percent, more preferably from about 0.01 to about 0.3 weight percent. Other suitable sequestering agents include gluconic acid, citric acid, tartaric acid and their salts, e.g. sodium salts.

The subject composition may be designed for a variety of osmolalities, but it is preferred that the composition is iso-osmal with respect to eye fluids. Specifically, it is preferred that the composition has an osmotic value of less than about 350 mOsm/kg, more preferably from about 175 to about 330 mOsm/kg, and most preferably from about 280 to about 320 mOsm/Kg. At least one osmolality adjusting agent may be employed in the composition to obtain the desired final osmolality. Examples of suitable osmolality adjusting agents include, but are not limited to sodium and potassium chloride, monosaccharides such as dextrose, calcium and magnesium chloride, and low molecular weight polyols such as glycerin and propylene glycol. Typically, these agents are used individually in amounts ranging from about 0.01 to 5 weight percent and preferably, from about 0.1 to about 2 weight percent.

The subject composition has an ophthalmically compatible pH, which generally will range between about 6 to about 8, and more preferably between 6.5 to 7.8, and most preferably about 7 to 7.5. Conventional buffers may be employed to obtain the desired pH value. As mentioned, tromethamine is known as a buffer for contact lens treating compositions. However, the compositions may include a supplemental buffering agent. In other words, the subject composition may include a “mixed buffer” of tromethamine and one or more supplemental buffer agents. Suitable buffers include borate buffers based on boric acid and/or sodium borate, phosphate buffers based on Na₂HPO₄, NaH₂PO₄ and/or KH₂PO₄, a citrate buffer based on potassium citrate and/or citric acid, sodium bicarbonate, and combinations thereof. Generally, buffers will be used in amounts ranging from about 0.05 to 2.5 weight percent, and preferably, from 0.1 to 1.5 weight percent.

The subject compositions may include a wetting agent to facilitate the composition wetting the surface of a contact lens soaked therein. Within the art, the term “humectant” is also commonly used to describe these materials.

A first class of wetting agents are polymer wetting agents. Examples include polyvinyl alcohol (PVA), polyvinyl pyrrolidone (PVP), cellulose derivatives and polyethylene glycol. Cellulose derivatives and PVA may be used to also increase viscosity of the composition, and offer this advantage if desired. Specific cellulose derivatives include hydroxypropyl methyl cellulose, carboxymethyl cellulose, methyl cellulose, hydroxyethyl cellulose, and cationic cellulose derivatives. As disclosed in U.S. Pat. No. 6,274,133, cationic cellulosic polymers also help prevent accumulation of lipids and proteins on a hydrophilic lens surface. Such polymers include commercially available water soluble polymers available under the CTFA (Cosmetic, Toiletry, and Fragrance Association) designation Polyquaternium-10, including the cationic cellulosic polymers available under the tradename UCARE® Polymer (Amerchol Corp., Edison, N.J.). Generally, these cationic cellulose polymers contain quaternized N,N-dimethyl amino groups along the cellulosic polymer chain.

Another class of wetting agents is non-polymeric wetting agents. Examples include glycerin, propylene glycol, and other non-polymeric diols and glycols.

The specific quantities of wetting agents used in the present invention will vary depending upon the application. However, the wetting agents will typically be included in an amount from about 0.01 to about 5 weight percent, preferably from about 0.1 to about 2 weight percent.

It will be understood that some components possess more than one functional attribute. For example, as mentioned, tromethamine provides the effect of preventing protein denaturation, but also contributes a buffering effect. Cellulose derivatives are suitable polymeric wetting agents, but are also referred to as “viscosity increasing agents” to increase viscosity of the composition if desired. Glycerin is a suitable non-polymeric wetting agent but may also contribute to adjusting tonicity.

The subject composition may include at least one ophthalmically acceptable surfactant, which may be either cationic, anionic, nonionic or amphoteric. Preferred surfactants are amphoteric or nonionic surfactants. The surfactant should be soluble in the aqueous solution and non-irritating to eye tissues. The surfactant serves mainly to facilitate removal of non-proteinaceous matter on the contact lens.

Many nonionic surfactants comprise one or more chains or polymeric components having oxyalkylene (—O—R—) repeats units wherein R has 2 to 6 carbon atoms. Representative non-ionic surfactants comprise block polymers of two or more different kinds of oxyalkylene repeat units, which ratio of different repeat units determines the HLB of the surfactant. For example, poloxamers are polyoxyethylene, polyoxypropylene block polymers and available under the tradename Pluronic™ (BASF Wyandotte Corp., Wyandotte, Mich.). Poloxamines are ethylene diamine adducts of such polyoxyethylene, polyoxypropylene block polymers available under the tradename Tetronic™ (BASF Wyandotte Corp.), including poloxamine 1107 (Tetronic 1107) having a molecular weight from about 7,500 to about 27,000 wherein at least 40 weight percent of said adduct is poly(oxyethylene). Other non-ionic surfactants include polyethylene glycol esters of fatty acids, e.g. coconut, polysorbate, polyoxyethylene or polyoxypropylene ethers of higher alkanes (C₁₂-C₁₈), polysorbate 20 available under the trademark Tween® 20 (Sigma Aldrich Company, St. Louis, Mo.), polyoxyethylene (23) lauryl ether available under the tradename Brij® 35 (Sigma Aldrich Company), polyoxyethyene (40) stearate available under the tradename Myrj® 52 (Sigma Aldrich Company), and polyoxyethylene (25) propylene glycol stearate available under the tradename Atlas® G 2612 (Sigma Aldrich Company).

Another useful class of surfactants are the hydroxyalkylphosphonates, such as those disclosed in U.S. Pat. No. 5,858,937 (Richards et al.), and available under the tradename Dequest® (Montsanto Co., St. Louis, Mo.).

Amphoteric surfactants suitable for use in a composition according to the present invention include materials of the type offered commercially under the trade name Miranol™ (Rhodia HPCII, Cranbury, N.J.). Another useful class of amphoteric surfactants is exemplified by cocoamidopropyl betaine, commercially available from various sources.

Various other ionic as well as amphoteric and anionic surfactants suitable for in the invention can be readily ascertained, in view of the foregoing description, from McCutcheon's Detergents and Emulsifiers, North American Edition, McCutcheon Division, MC Publishing Co., Glen Rock, N.J. 07452 and the CTFA International Cosmetic Ingredient Handbook, Published by The Cosmetic, Toiletry, and Fragrance Association, Washington, D.C.

Preferably, the surfactants, when present, are employed in a total amount from about 0.01 to about 15 weight percent, preferably 0.1 to 5.0 weight percent, and most preferably 0.1 to 1.5 weight percent.

As an illustration of the present invention, several examples are provided below. These examples serve only to further illustrate aspects of the invention and should not be construed as limiting the invention.

### EXAMPLE 1

A series of 10-ml test solutions, listed in Table 1 below, were prepared. Each solution included saline and 20 mM of buffering agent as specified in Table 1 below. To each test solution was added 1 mg/ml of hen egg lysozyme as well as a phosphate buffered saline (PBS) control. The test solutions were mixed slowly with a stir bar until the lysozyme was incorporated into the solutions. Five ml of each lysozyme-containing test solution was retained as the unheated control. The remaining 5 ml of each lysozyme-containing test solution were placed in glass less vials, capped with silicone stoppers and incubated in a shaking water bath at 80° C., 40 revolutions per minute (rpm) for 1 hour—these heating conditions are sufficient to denature the lysozyme, absent a stabilization effect provided by the buffering agents.

The vials were allowed to come to ambient temperature before testing. A 0.00025 g/ml suspension of M. luteus was prepared from lyophilized cells in PBS. The suspension was continually mixed on a stir plate during the testing period to prevent the suspension from settling.

For each set of test solutions, the following were tested (sample): a heated lysozyme-containing test solution (“lysozyme+heat”); an unheated lysozyme-containing test solution (“lysozyme/no heat”; and a test solution without lysozyme (“no lysozyme”). One ml of each sample was placed into a glass test tube to which 9 ml of M. luteus suspension was added and vortexed. A 1-ml sub-sample was placed into a disposable cuvette and evaluated on a UV-vis spectrophotometer at 450 nm. This procedure was performed for each sample at 0, 5 and 10 minutes. Each of the solutions were evaluated in triplicate. Each of the three optical density measurements from the triplicate samples were averaged. The resulting mean value for the 5 and 10 minute time points was used to determine the Percentage Change at the 5 and 10 minute time points.

As can be seen in Table 1, the compositions containing tromethamine were generally more effective at stabilizing the protein against denaturation. Thus, these compositions are expected to reduce the amount of denatured protein that bind to a contact lens surface, noting that native protein is removed from a contact lens relatively easily, whereas denatured protein adheres tenaciously to a contact lens surface.

TABLE 1

| | | Time | | | Percent Change | |
|---|---|---|---|---|---|---|
| Solution | Treatment | 0 Min | 5 Min | 10 Min | 5 Min | 10 Min |
| Borate | lysozyme/no heat | 0.619 | 0.053 | 0.034 | 91.44 | 94.51 |
| | lysozyme + heat | 0.872 | 0.681 | 0.390 | 21.90 | 55.28 |
| | no lysozyme | 0.853 | 0.853 | 0.854 | 0.00 | −0.12 |
| Phosphate | lysozyme/no heat | 0.634 | 0.052 | 0.029 | 91.80 | 95.43 |
| | lysozyme + heat | 0.861 | 0.858 | 0.852 | 0.34 | 1.05 |
| | no lysozyme | 0.856 | 0.852 | 0.854 | 0.47 | 0.23 |
| Tris | lysozyme/no heat | 0.654 | 0.048 | 0.028 | 92.66 | 95.72 |
| | lysozyme + heat | 0.810 | 0.154 | 0.117 | 80.99 | 85.56 |
| | no lysozyme | 0.859 | 0.854 | 0.854 | 0.58 | 0.58 |
| Dequest | lysozyme/no heat | 0.629 | 0.051 | 0.032 | 91.89 | 94.91 |
| | lysozyme + heat | 0.857 | 0.848 | 0.842 | 1.05 | 1.75 |
| | no lysozyme | 0.852 | 0.850 | 0.848 | 0.23 | 0.47 |
| Citrate | lysozyme/no heat | 0.654 | 0.049 | 0.030 | 92.51 | 95.41 |
| | lysozyme + heat | 0.877 | 0.851 | 0.785 | 2.96 | 10.49 |
| | no lysozyme | 0.857 | 0.850 | 0.850 | 0.82 | 0.82 |
| Citrate + Phosphate | lysozyme/no heat | 0.611 | 0.057 | 0.037 | 90.67 | 93.94 |
| | lysozyme + heat | 0.864 | 0.839 | 0.827 | 2.89 | 4.28 |
| | no lysozyme | 0.852 | 0.849 | 0.856 | 0.35 | −0.47 |
| Citrate + Borate | lysozyme/no heat | 0.602 | 0.050 | 0.033 | 91.69 | 94.52 |
| | lysozyme + heat | 0.854 | 0.817 | 0.785 | 4.33 | 8.08 |
| | no lysozyme | 0.848 | 0.844 | 0.846 | 0.47 | 0.24 |
| Borate + Tris | lysozyme/no heat | 0.564 | 0.051 | 0.036 | 90.96 | 93.62 |
| | lysozyme + heat | 0.836 | 0.216 | 0.167 | 74.16 | 80.02 |
| | no lysozyme | 0.847 | 0.841 | 0.843 | 0.71 | 0.47 |
| Phosphate + Borate | lysozyme/no heat | 0.598 | 0.050 | 0.031 | 91.64 | 94.82 |
| | lysozyme + heat | 0.847 | 0.841 | 0.838 | 0.71 | 1.06 |
| | no lysozyme | 0.848 | 0.852 | 0.847 | −0.47 | 0.12 |
| Tris + Dequest | lysozyme/no heat | 0.575 | 0.048 | 0.030 | 91.65 | 94.78 |
| | lysozyme + heat | 0.846 | 0.605 | 0.349 | 29.98 | 59.61 |
| | no lysozyme | 0.830 | 0.843 | 0.843 | −1.57 | −1.57 |
| M. Luteus + | no lysozyme | 0.836 | 0.849 | 0.838 | −1.56 | −0.24 |

PBS - Control

### EXAMPLES 2 THROUGH 5

Representative compositions of the present invention are set forth below in Table 2. The compositions identified in Table 2 as Examples 2 through 5 were prepared according to the following method. The non-polymeric components, such as tromethamine, tromethamine HCl, sodium chloride, EDTA, Dequest, sodium borate and boric acid, were added sequentially to a volume of heated water (about 50° C.) that amounts to about 70-85% of the final batch volume. This addition was done under constant agitation, and each component was allowed to dissolve or disperse before adding the next component. Subsequently, Tetronic 1107 and PHMB were added under agitation, ensuring adequate dispersion of the polymer. The resulting solution was mixed until complete dissolution was achieved. The batch was cooled under agitation to room temperature. The pH was adjusted to about 7.1-7.5 by incrementally adding 1N NaOH or 1N HCl, and then the final volume was achieved by adding water (at 20-30° C.) and mixing for at least 15 minutes.

TABLE 2

| Ingredients (w/w %) | Example 2 | Example 3 | Example 4 | Example 5 |
|---|---|---|---|---|
| Boric Acid | 0.121 | 0.66 | 0.0618 | — |
| Sodium Borate | 0.0183 | 0.1 | — | — |
| Triethanolamine | — | 0.129 | 0.121 | — |
| Triethanolamine | — | 0.15 | — | 0.1576 |
| Dequest 2016 30% | 0.1 | 0.1 | 0.1 | 0.98 |
| Tetronic 1107 | 1 | 1 | 1 | 1 |
| EDTA | 0.11 | 0.11 | 0.11 | 0.11 |
| NaCl | 0.758 | 0.716 | 0.82 | 0.655 |
| PHMB | 1 ppm | 1 ppm | 1 ppm | 1 ppm |

| | |
|---|---|
| 1 N HCl or NaOH | Adjust pH 7.1 to 7.5 |
| Purified water | q.s. to 100 |

The compositions identified as Examples 2 through 5 in Table 2 above, along with the marketed multi-purpose solutions identified in Table 3 below, were tested according to the procedure described in Example 1 the results of which are set forth below in Table 4.

TABLE 3

| Marketed | |
|---|---|
| Multi-Purpose Solution | Buffer System |
| MP A | Borate |
| MP B | Borate/Citrate |
| MP C | Phosphate |
| MP D | Phosphate |

As shown by the data presented in Table 4 below, the multi-purpose solutions containing tromethamine were generally more effective at stabilizing the protein against denaturation.

TABLE 4

| | | Time | | | Percent Change | |
|---|---|---|---|---|---|---|
| Solution | Treatment | 0 Min | 5 Min | 10 Min | 5 Min | 10 Min |
| Example 2 | lysozyme/no heat | 0.771 | 0.087 | 0.056 | 88.67 | 92.78 |
| | lysozyme + heat | 1.019 | 0.770 | 0.501 | 24.46 | 50.85 |
| | no lysozyme | 1.006 | 1.001 | 1.002 | 0.50 | 0.40 |
| Example 3 | lysozyme/no heat | 0.807 | 0.078 | 0.05 | 90.29 | 93.80 |
| | lysozyme + heat | 0.965 | 0.175 | 0.139 | 81.86 | 85.59 |
| | no lysozyme | 0.958 | 1.002 | 0.998 | −4.66 | −4.21 |
| Example 4 | lysozyme/no heat | 0.737 | 0.107 | 0.055 | 85.48 | 92.53 |
| | lysozyme + heat | 0.991 | 0.289 | 0.181 | 70.80 | 81.74 |
| | no lysozyme | 0.999 | 0.996 | 0.992 | 0.33 | 0.70 |
| Example 5 | lysozyme/no heat | 0.777 | 0.081 | 0.051 | 89.62 | 93.48 |
| | lysozyme + heat | 1.008 | 0.611 | 0.3363 | 39.38 | 66.63 |
| | no lysozyme | 0.996 | 0.989 | 0.986 | 0.74 | 1.04 |
| MP A | lysozyme/no heat | 0.716 | 0.093 | 0.054 | 86.96 | 92.41 |
| | lysozyme + heat | 1.022 | 1.003 | 0.984 | 1.83 | 3.72 |
| | no lysozyme | 1.008 | 1.004 | 1.000 | 0.46 | 0.83 |
| MP B | lysozyme/no heat | 0.822 | 0.119 | 0.064 | 85.53 | 92.22 |
| | lysozyme + heat | 1.001 | 0.996 | 1.000 | 0.43 | 0.03 |
| | no lysozyme | 0.993 | 0.989 | 0.985 | 0.44 | 0.81 |
| MP C | lysozyme/no heat | 0.770 | 0.099 | 0.056 | 87.06 | 92.68 |
| | lysozyme + heat | 1.192 | 1.180 | 1.174 | 0.98 | 1.51 |
| | no lysozyme | 0.980 | 0.976 | 0.974 | 0.41 | 0.65 |
| MP D | lysozyme/no heat | 0.767 | 0.079 | 0.048 | 89.62 | 93.74 |
| | lysozyme + heat | 0.996 | 0.980 | 0.969 | 1.57 | 2.71 |
| | no lysozyme | 0.989 | 0.982 | 0.981 | 0.64 | 0.74 |
| M. Luteus + | no lysozyme | 0.884 | 0.881 | 0.879 | 0.30 | 0.45 |

PBS - Control

Although various preferred embodiments have been illustrated, many other modifications and variations of the present invention are possible to the skilled practitioner. It is therefore understood that, within the scope of the claims, the present invention can be practiced other than as herein specifically described.

We claim:

1. An ophthalmically acceptable composition comprising
surfactants including poloxamer 407 and poloxamine 1107; and
a biguanide anti-microbial agent in an amount effective to disinfect a contact lens in an aqueous solution.

2. The composition of claim 1, wherein the total amount of surfactants ranges from about 0.01 wt. % to about 15 wt. %.

3. The composition of claim 1, wherein the total amount of surfactants ranges from about 0.1 wt. % to about 5.0 wt. %.

4. The composition of claim 1, further comprising a cationic polysaccharide.

5. The composition of claim 4, wherein the amount of cationic polysaccharide ranges from about 0.01 to about 5 wt. %.

6. The composition of claim 1, further comprising a polyquaternium-10 cationic polysaccharide.

7. The composition of claim 6, wherein the amount of polyquaternium-10 cationic polysaccharide ranges from about 0.01 to about 5 wt. %

8. The composition of claim 1, further comprising a hydroxyalkyl phosphonate.

9. The composition of claim 1, further comprising a buffer selected from the group consisting of borate buffers, phosphate buffers, citrate buffers, bicarbonate buffers and combinations thereof.

10. A contact lens cleaning and disinfecting solution comprising:
surfactant(s) including poloxamine 1107 and poloxomer 407; and a biguanide anti-microbial agent in an amount effective to disinfect a contact lens in an aqueous solution.

11. The composition of claim 10 wherein the total amount of surfactants ranges from about 0.05 wt. % to about 15 wt. %.

12. The composition of claim 10, wherein the total amount of surfactants are from about 0.01 wt. % to about 5 wt. %.

13. The composition of claim 10, further comprising a cationic polysaccharide.

14. The composition of claim 10, wherein the amount of cationic polysaccharide range from about 0.01 wt. % to about 5 wt. %.

15. The composition of claim 10, further comprising a polyquaternium-10 cationic polysaccharide.

16. The composition of claim 15 wherein the amount of polyquaternium-10 catonic polysaccharide ranges from about 0.01 wt. % to about 5 wt. %.

17. The composition of claim 10 further comprising a hydroxyalkyl phosphonate.

18. The composition of claim 10 further comprising a buffer selected from the group consisting of borate buffers, phosphate buffers, citrate buffers, bicarbonate buffers and combinations thereof.

19. The composition of claim 10, having a pH ranging from about 6 to about 8.

20. A method of cleaning a disinfecting contact lenses comprising:
soaking the contact lens in an aqueous solution comprising surfactants including poloxomine 1107 and poloxomer 407; and a biguanide antimicrobial agent in amount effective to disinfect contact lens.

21. The method of claim 20, further comprising rinsing the contact lens after soaking.

22. The method of claim 20, wherein the composition has a total amount of surfactant ranging from about 0.01 wt. % to about 15 wt. %.

23. The method of claim 20, wherein the total amount of surfactants ranges from about 0.01 wt. % to 5 wt. %.

24. The method of claim 20, further comprising a cationic polysaccharide.

25. The method of claim 24, wherein the amount of cationic polysaccharide ranges from about 0.01 wt. % to about 5 wt. %.

26. The method of claim 20, wherein the composition comprises polyquaternium-10 cationic polysaccharide.

27. The method of claim 26, wherein the amount of polyquaternium-10 cationic polysaccharide ranges from about 0.01 wt. % to about 5 wt. %.

28. The method of claim 20, wherein the composition further comprises hydroxyalkyl phosphonate.

29. The method of claim 20, wherein the composition further comprises a buffer selected from the group consisting of borate buffers, phosphate buffers, citrate buffers, bicarbonate buffers and combinations thereof.

30. The method of claim 20, wherein the composition has a pH ranging from about 6 to about 8.
